(19) United States
(12) Patent Application Publication
(10) Pub. No.: US 2008/0217349 A1
(43) Pub. Date: Sep. 11, 2008

(54) Automatic Machine for Leasing or Selling of Articles Like Dvd in Cassettes

(75) Inventor: Kristian Silbers, Boras (SE)

Correspondence Address: ROBERT PLATT BELL;REGISTERED PATENT ATTORNEY, P.O. BOX 13165, Jekyll Island, GA, 31527, US

(73) Assignee: MGI GP, IMC., Baltimore, MD (US)

(21) Appl. No.: 11/995,125

(22) PCT Filed: Jul. 11, 2006
(86) PCT No.: PCT/SE06/00871

§ 371 Date: Jan. 9, 2008

(30) Foreign Application Priority Data
Jul. 12, 2005 (SE) 0501655-5

(51) Int. Cl. G07F 11/58

(52) U.S. Cl. 221/13

(57) ABSTRACT

An automatic machine for leasing or selling of flat articles to be chosen, such as DVDs in cassettes and the like, includes a support (8) with a shelf element (9), wherein the articles to be chosen may be stored, preferably partly in a vertical y-direction and partly in a horizontal x-direction. Conveyor (10) conveys articles to be chosen in the x and y directions, and in a direction perpendicular to the x-y plane, or z-direction. A display displays symbols for the article to be chosen, such that a relatively large assortment may be shown, whereas the display is equipped with a mechanism for selecting of articles to be chosen. A card reader is provided for paying of fees for leasing or buying of articles. The casing has an opening for delivering or feeding of articles to be chosen, in the z-direction. A second conveying element (17) is provided with a transmitter/receiver unit for identifying of articles to be chosen, by transmittance and receiving of an electromagnetic wave to and from a transponder at the article, such that returned articles can be automatically placed back in the correct location.

### CROSS-REFERENCE TO RELATED APPLICATIONS

The present application is a §371 National Stage U.S. Patent Application of PCT Application Ser. No. PCT/SE2006/000871, filed Jul. 11, 2006 which in turn claims priority from Swedish Patent Application Ser. No. 0501655.5 filed on Jul. 12, 2005, both of which are incorporated herein by reference.

### FIELD OF THE INVENTION

The present invention relates to an automatic machine for leasing or selling of flat articles to be chosen, with two substantially plane sides, joined by edges, such as DVDs in cassettes and the like.

### BACKGROUND OF THE INVENTION

Leasing and selling of such articles such as DVDs has increased substantially in recent years. Until now this activity has been managed substantially manually, through retail outlets. There is however, a demand for a possibility to carry out this activity greatly independently of personal and business hours, that is to say open hours of such retail outlets. Thus a requirement remains in the art for an automated machine for dispensing DVDs and the like.

### SUMMARY OF THE INVENTION

The object of the present invention is thus to achieve an automatic machine, which is versatile and efficient in use but may yet be sold at a cost efficient price.

According to the invention such an automatic machine is characterized primarily in that the conveyor comprises a first conveyor element, which is movable in an x-y direction, and a second conveyor element movable in relationship to the first conveyor element in the z-direction, whereas the second conveyor element is provided with driving belts, arranged to drive the article, at least at one edge of the article, in the z-direction in relationship to the second conveyor element for placing of the article in the shelf element or withdrawal of the article from there

The second conveyor element is provided with a transmitter/receiver unit for identifying of articles to be chosen, which transmitter/receiver unit transmits an electromagnetic wave for the activation of a transponder, provided at one side of the article to be chosen for retransmission of identifying information to the transmitter/receiver unit.

### BRIEF DESCRIPTION OF THE DRAWINGS

Many embodiments are per se possible within the scope of the invention. In the following a preferred embodiment of the automatic machine according to the invention is disclosed, reference being made to the enclosed schematic Figures, of which:

FIG. 1 shows, in perspective, a casing to an automatic machine,

FIG. 2 shows a side view of a portion of the automatic machine,

FIG. 3 shows a view perpendicularly to the left portion of FIG. 2, and

FIG. 4 shows, in perspective, a detail from FIGS. 3 and 4.

### DETAILED DESCRIPTION OF THE INVENTION

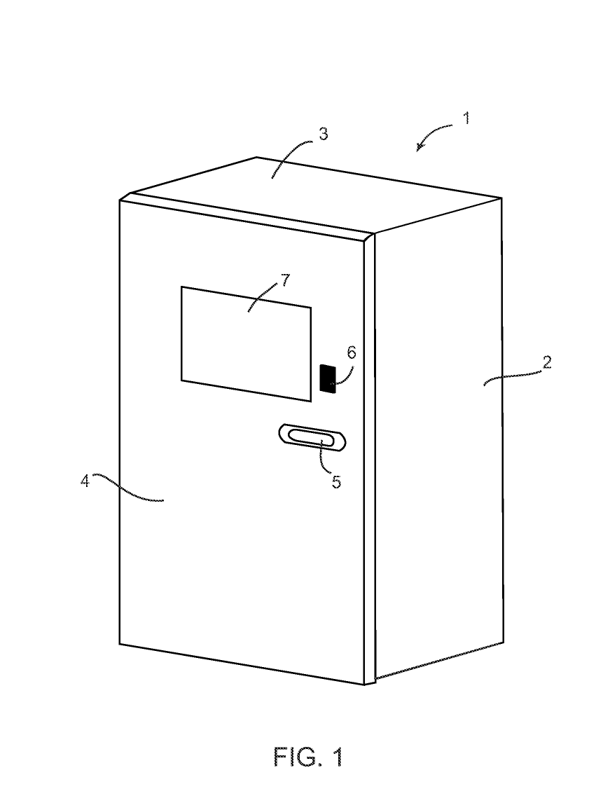

In FIG. 1, the automatic machine of the present invention is shown generally marked by 1, comprising two sides, from which one is shown marked by 2, and an upper side 3 and a cover 4, which may be opened to access the interior of the machine 1. An opening 5 in cover 4 is provided for feeding and withdrawal of articles to be chosen, such as DVDs and the like. Furthermore there is shown at the cover 4 a portion of a paying machine, that is to say it's a credit or debit card reader or the like, marked by 6, as well as a display 7. These will be described in more detail in the following description.

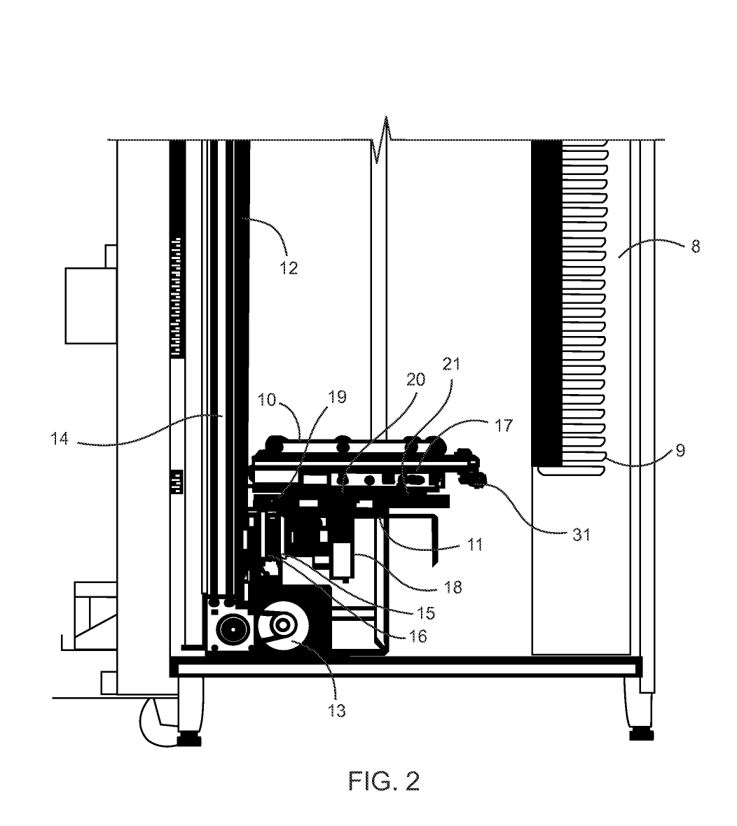

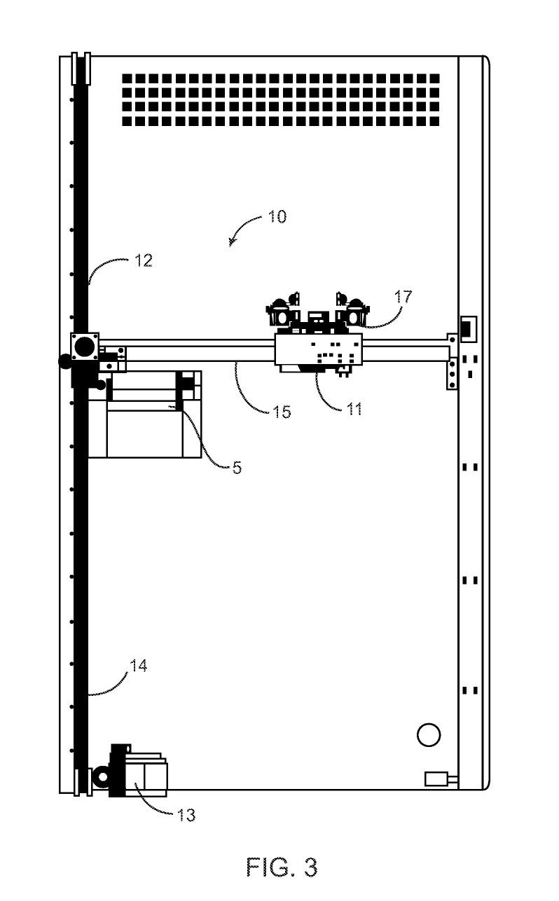

Referring to FIGS. 2 and 3, there is shown a portion of a support 8 with shelf elements 9 placed vertically, (i.e., in the y-direction), and horizontally, (i.e., in the x-direction) for storing the articles to be chosen, such as DVDs and the like. A conveyor, generally marked by 10, comprises a first conveyor element 11, controllable in the x-y direction along a vertical first control element 12, driven by a stepper motor 13, which drives a driving belt 14, in connection with a second control element 15, along which the conveyor element 11 is controllable in horizontal direction by a driving belt 16, also driven by a stepper motor.

A second conveyor element 17 is provided, controllable in relationship to the first conveyor element 11, perpendicular to the x-y plane, (i.e., in the z-direction), by a stepper motor 18. The relative position between the first conveyor element 11 and the second conveyor element 17 is indicated by first, second and third position sensors 19, 20, 21 for the z-direction, as shown in FIG. 2.

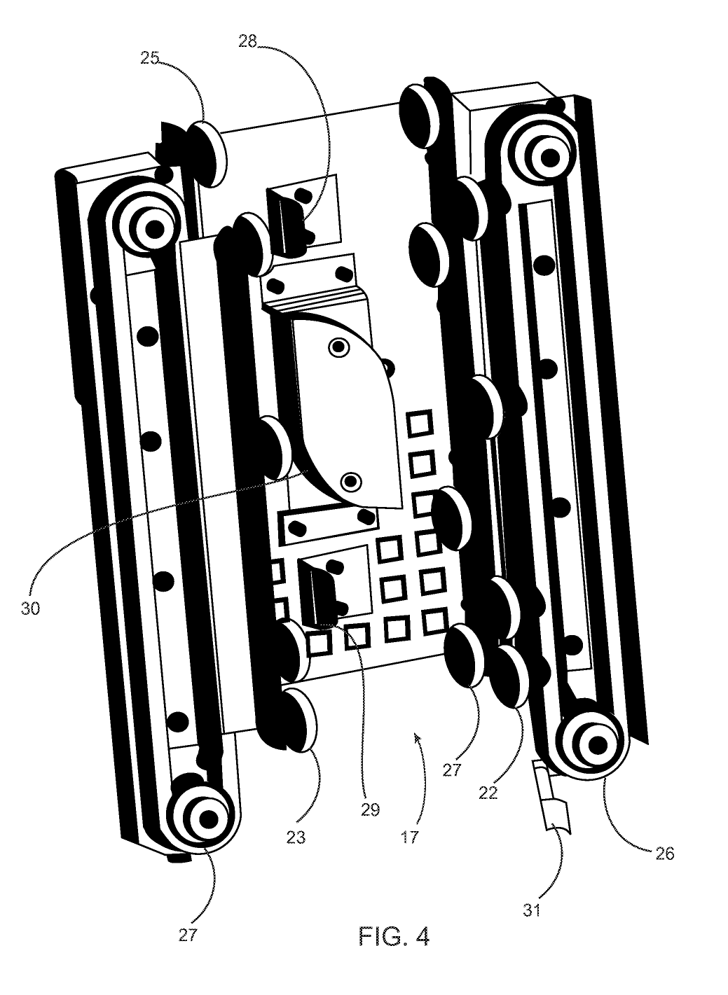

The second conveyor element 17 is shown more distinctly in FIG. 4. Second conveyer element 17 is provided with four upper steering wheels 22 and 23 and four lower steering wheels 24 and 25 at each side for steering an article to be chosen. Steering wheels 22 and 24, and 23 and 25 may be driven forwards or backwards in the z-direction by driving belt 26 at one side and by driving belt 27 at the other side, respectively. The driving may be achieved by one single driving belt at one side, if corresponding steering wheels are provided with vertical axes at the other side, but the embodiment illustrated in FIG. 4 shown is more reliable, and is thus preferred.

At the bottom of the second conveyor element 17 there are provided fourth and fifth position sensors 28 and 29 to control the position of the article to be chosen in relationship to second conveyor element 17. At the bottom of second conveyor element 17 there is also provided a transmitter/receiver 30 for transmitting and receiving of an electromagnetic wave, preferably in the microwave region, in cooperation with a (not shown) identifying transponder, provided at the lower side of the article to be chosen. The transmitter thus activates the transponder to transmit an identifying signal.

Referring back to FIG. 1, display 7 shows symbols such as pictures or signs for the articles to be chosen. According to technique, known per se, there is a first means, for moving the symbols within a relatively large assortment and a second means for selecting an article to be chosen, for example provided to be controlled by a touch of the display for indication of a chosen article. As already mentioned there is a card reader 6 at the front side of the casing 1, at the cover 4, for a paying routine according to techniques known in the art. The automatic machine comprises a (not shown) computer unit with a memory unit for co-ordination of the choice of articles, identifying of same, control of withdrawal from or feeding into the shelf element 9 of the support 8 and the paying routine. The automatic machine operates as follows.

For leasing or purchase of an article to be chosen (such as a DVD) the customer chooses, via display 7 an article and indicates via display 7 if the article shall be leased or purchased. The cost, or the leasing conditions and requested paying routine are indicated on display 7. The location of the chosen article in the casing 8, (i.e., in a shelf element 9) in casing 8 is registered in the memory unit of the computer unit.

The computer unit orders conveyor 10 to set first conveyor element 11 in a corresponding x-y coordinate position, whereupon the second conveyor element 17 is ordered to move forwards in the z-direction to the article chosen, whereupon the driving belts 26, 27 are activated to retract the article chosen, whereupon the first conveyor 19 is ordered to set the x-y coordinates for first conveyor element 11 to a position, where the second conveyor element 17, assisted by driving belts 26,27 can convey the article chosen out through opening 5.

As mentioned above, before this, the article chosen is identified by transmitter/receiver 30 in cooperation with a transponder at the lower side of the article. The paying routine via card reader 6 may be performed at a chosen moment during the conveying procedure just described. When returning a leased article chosen the customer inserts it through the opening 5, and the article is drawn in by the second conveyor element 17 by aid of the driving belts 26 and 27. The article is identified using the transmitter/receiver 30 in cooperation with a transponder at the lower side of the article, and conveyor 10 is ordered to convey the article to a predetermined shelf element 9.

When mounting the automatic machine it may happen, that the position relationship between the conveyor and the shelf elements is not distinctly defined by the design, due to variations in bending, sheet tension and supporting structure. In order to have the automatic machine operate without disturbances a preferred embodiment defines, that conveyor 10 and thus preferably first conveying element 11 carries a sensor, in FIGS. 2 and 3 marked by 31, and at support 8 provided (in the Figures, not shown) with this sensor such cooperating position elements, that the conveyor 10 is brought to find the correct x and y coordinates for placing the article on shelf element 9 or withdrawal of the article from shelf element 9. A program in the computer unit performs this correction. The sensor is preferably optical and the position elements of corresponding art.

While the preferred embodiment and various alternative embodiments of the invention have been disclosed and described in detail herein, it may be apparent to those skilled in the art that various changes in form and detail may be made therein without departing from the spirit and scope thereof.

1. A machine for leasing or selling of articles to be chosen, comprising:
a) a support containing a shelf element, wherein the articles to be chosen may be stored, lying with one side substantially horizontal, whereas the storing is performed partly in a vertical y-direction, and partly in a horizontal x-direction;
b) a conveyor for conveying articles to be chosen in the x and y directions, also equipped for conveying of the articles to be chosen in a z-direction perpendicular to an x-y plane;
c) a display for showing of symbols like pictures or signs for the article to be chosen, with a manually controlled first means for moving the symbols, such that a large assortment may be shown, whereas the display is equipped with second means fors selecting an article to be chosen;
d) a paying machine with card reader for paying of fees for leasing or buying of articles to be chosen;
e) a computer unit for controlling the conveyor, the display with its functions, and the paying routines;
f) a casing with an opening for delivering or feeding of articles to be chosen, in the z-direction, the conveyer comprising a first conveying element which is controllable in the x-y direction, and a second conveying element controllable in relationship to the first conveying element in the z-direction, whereas the second conveying element is provided with driving belts, provided to drive the article at least at one edge of same in the z-direction in relationship to the second conveying element, for placing the article in the shelf element or for withdrawal of the article from there, whereas the second conveying element is provided with a transmitter/receiver unit for identifying of articles to be chosen, which transmitter/receiver unit transmits an electromagnetic wave for the activation of a transponder, provided at one side of the article to be chosen for retransmission of identifying information to the transmitter/receiver unit.

2. The machine according to claim 1, wherein the conveyor is provided with a sensor and the support is provided with position elements, cooperating with said sensor such that the conveyor is brought to find the correct x and y coordinates for placing the article onto the shelf element or the withdrawal of the article from the shelf element.

3. A vending machine for renting articles to a consumer, each article provided in a corresponding case, each corresponding case containing a transponder identifying the articles, the vending machine comprising:
a rack for storing a plurality of the articles provided in their corresponding cases;
a multi-axis conveyor for storing and retrieving each of the plurality of the articles provided in their corresponding cases;
a cabinet for housing the rack and the multi-axis conveyor;
a display, on an exterior portion of the cabinet for allowing a consumer to select one of the articles to rent, wherein the multi-axis conveyor retrieves a corresponding article in its corresponding case in response to a user selection of one of the articles to rent;
at least one opening in the cabinet, for dispensing the article to the consumer and for receiving the article in the corresponding case the consumer has finished renting the article;
a transmitter/receiver in the cabinet, for transmitting a signal to the transponder in the case corresponding to the article received through the opening, receiving a signal from the transmitter identifying the article received through the opening, and identifying the article in the corresponding case,
wherein the multi-axis conveyor returns the article and corresponding case to a corresponding position on the rack for later vending.

4. The vending machine of claim 3, wherein the multi-axis conveyor comprises a three-axis conveyor.

5. The vending machine of claim 3, where the articles comprise DVDs and the corresponding case comprises a DVD case.

6. A method of renting articles to consumers, each article provided in a corresponding case, each corresponding case containing a transponder identifying the articles, the method comprising the steps of:
storing in a rack provided in a cabinet housing the rack and the multi-axis conveyor, a plurality of the articles provided in their corresponding cases;
selecting, by the consumer, through a display on an exterior portion of the cabinet, one of the articles to rent,
retrieving, using the multi-axis conveyor, corresponding article in its corresponding case in response to a user selection of one of the articles to rent;
dispensing, to the consumer, the corresponding article in its corresponding case through an opening in the cabinet and receiving the article and the corresponding case through an opening in the cabinet after the consumer has finished renting the article;
storing, using a multi-axis conveyor, the article in the corresponding case in the rack, wherein the multi-axis conveyor returns the article and corresponding case to a corresponding position on the rack for later vending.

7. The method of claim 6, wherein the multi-axis conveyor comprises a three-axis conveyor.

8. The method of claim 6, where the articles comprise DVDs and the corresponding case comprises a DVD case.
